(19) United States
(12) Patent Application Publication
(10) Pub. No.: US 2009/0155673 A1
(43) Pub. Date: Jun. 18, 2009

(54) Battery Management System

(76) Inventor: Daniel Ross Northcott, Winnipeg (CA)

Correspondence Address: ADE & COMPANY INC., 2157 Henderson Highway, WINNIPEG, MB, R2G1P9, CA

(21) Appl. No.: 12/327,045

(22) Filed: Dec. 3, 2008

Related U.S. Application Data
(60) Provisional application No. 61/012,952, filed on Dec. 12, 2007.

(51) Int. Cl. H01M 10/50; H01M 10/42

(52) U.S. Cl. 429/62; 429/61

(57) ABSTRACT

A battery management system for monitoring a plurality of interconnected batteries comprises a plurality of interconnected modules arranged for connection to respective ones of the batteries. Each module comprises a negative terminal connector, a positive terminal connector, a voltage sensor for measuring voltage between the terminals, a communication port arranged to communicate the sensed voltage to other modules, and a controller arranged to selectively connect a resistive element between the negative terminal connector and the positive terminal connector of the respective battery responsive to the sensed voltage being greater than sensed voltages of other modules. A temperature sensor on each module measures a temperature through the terminal of the battery for communication to the system. A printed circuit board, arranged to be supported directly on one of the battery terminals, commonly supports the voltage sensor, the temperature sensor and the communication port thereon.

This application claims the benefit under 35 U.S.C. 119(e) of U.S. provisional application Ser. No. 61/012,952, filed Dec. 12, 2007.

### FIELD OF THE INVENTION

The present invention relates to a battery management system for balancing voltage among a plurality of interconnected batteries, and more particularly comprises a battery management system comprising a plurality of interchangeable modules for connection with the plurality of interconnected batteries respectively.

### BACKGROUND

Battery management systems are known to monitor voltage and temperature of each battery in a plurality of interconnected batteries, for example 12 volt batteries similar to those in vehicles. A problem occurs when several batteries are in series and discharged, that is imbalances in voltage occur. A typical battery management system will try to balance these differences between batteries or cells as well as providing or facilitating some protection to the batteries or cells. Some systems are known that can manage a set number of cells or that are programmable to be used in a few different ways, usually by using a lot of wires between the batteries and some master controller. These systems are accordingly complex to install and maintain. Some known systems require that you tape or glue a temperature sensor onto the battery, and wire it back to some controller. Most known systems are inherently designed for a specific application, which is typically only suited for large volume production and where there is technical expertise available.

### SUMMARY OF THE INVENTION

According to one aspect of the invention there is provided a battery management system for monitoring a plurality of interconnected batteries, the system comprising a plurality of modules arranged for connection to respective ones of the batteries, each module comprising:

a negative terminal connector arranged for connection to a negative terminal of the respective battery;

a positive terminal connector arranged for connection to a positive terminal of the respective battery;

a voltage sensor arranged for measuring a voltage between the negative terminal connector and the positive terminal connector;

a communication port arranged to communicate the voltage sensed by the voltage sensor with the communication ports of other ones of the modules;

a resistive element arranged to be selectively connected between the negative terminal connector and the positive terminal connector; and

a controller arranged to connect the resistive element between the negative terminal connector and the positive terminal connector responsive to the voltage sensed by the voltage sensor being greater than a voltage of other ones of the batteries which is sensed by the voltage sensors of the respective modules.

By providing a plurality of modules, each with their own controller, each controller can operate autonomously to connect the respective resistive element between the respective negative terminal connector and the respective positive terminal connector independently of operation the other controllers. The modules can thus be readily implemented and interchanged without a complex main controller being required to be reconfigured as in some prior art configurations of battery management systems. Furthermore, the modules are all alike and accordingly can be readily manufactured in large number to reduce cost of manufacturing. Installation is simplified and reduced in cost as well as minimal skill is required to interconnect a plurality of modules of identical configuration.

Preferably the controller of each module is arranged to autonomously assign a unique identification to the module relative to other modules communicating with one another through the respective communication ports.

The controller is preferably arranged to connect the resistive element between the negative terminal connector and the positive terminal connector only when the voltage sensed by the respective voltage sensor is greater than voltages of other ones of the batteries which are sensed by the voltage sensors of the respective modules of the other one of the batteries. Furthermore, in some embodiments, the controller may only connect the resistive element between the negative terminal connector and the positive terminal connector when the sensed voltages exceeds the other voltages by a prescribed allowance range so that very small differences are permitted and so that the resistive element is not excessively cycled between on and off states. In yet further arrangements, the connection of the resistive element between the negative terminal connector and the positive terminal connector may be prevented if the battery is near full charge and/or near depleted of charge.

The system may be provided in combination with a plurality of batteries connected in parallel, in series, or any combination thereof.

The negative terminal connector, the voltage sensor, the communication port, the resistive element, and the controller of each module are preferably all commonly supported on a common printed circuit board of the module, which may further be arranged to be supported directly on a terminal of the respective battery.

The communication port of each module is arranged to communicate with other modules on a common serial communication network using a serial communication protocol, for example SAE J1939 CAN Bus.

When the system is provided in combination with a device which consumes electrical power from the plurality of interconnected batteries, the device may include an operating condition responsive to information communicated by the modules through their respective communication ports to the serial communication network. For example operation of a battery powered vehicle may be controlled responsive to voltage or temperature conditions of the batteries as communicated by the modules.

Preferably each module includes a temperature sensor arranged for measuring a temperature of the respective battery and the controller is arranged to broadcast the temperature sensed by the respective temperature sensor onto the serial communication network through the respective communication port.

The temperature sensor may be arranged for measuring a temperature of the battery through one of the terminal connectors.

The temperature sensor of each module may also be supported on the common printed circuit board with the controller and the negative terminal connector of the respective module.

According to a second aspect of the present invention there is provided a module for monitoring a battery interconnected with other batteries in a battery management system, the module comprising:

a negative terminal connector arranged for connection to a negative terminal of the battery;

a positive terminal connector arranged for connection to a positive terminal of the battery;

a voltage sensor arranged for measuring a voltage between the negative terminal connector and the positive terminal connector;

a temperature sensor arranged for measuring a temperature of the battery;

a communication port arranged to transmit the voltage measured by the voltage sensor and the temperature measured by the temperature sensor to the battery management system;

wherein the temperature sensor is connected to one of the terminal connectors so as to be arranged to measure a temperature of the battery through the respective terminal of the battery.

The battery management system referred to above may comprise a network of modules monitoring respective batteries and which communicate with one another over a common network, for example through a serial connection.

In some configurations, the battery management system may refer to an overall system including a control system of a device which consumes power from the batteries, or which uses the same serial connection, in addition to the modules. In this instance, the interconnected modules communicate both with one another and the control system of the consuming device over a common network or through a common serial connection.

According to another aspect of the present invention there is provided a module for monitoring a battery interconnected with other batteries in a battery management system, the module comprising:

a negative terminal connector arranged for connection to a negative terminal of the battery;

a positive terminal connector arranged for connection to a positive terminal of the battery;

a voltage sensor arranged for measuring a voltage between the negative terminal connector and the positive terminal connector;

a temperature sensor arranged for measuring a temperature of the battery; and

a communication port arranged to transmit the voltage measured by the voltage sensor and the temperature measured by the temperature sensor to the battery management system;

wherein there is provided a printed circuit board commonly supporting the voltage sensor, the temperature sensor and the communication port thereon and the printed circuit board is arranged to be supported directly on one of the terminals of the battery.

One embodiment of the invention will now be described in conjunction with the accompanying drawings in which:

### BRIEF DESCRIPTION OF THE DRAWINGS

FIG. 1 is schematic representation of the battery management system installed on a plurality of interconnected batteries.

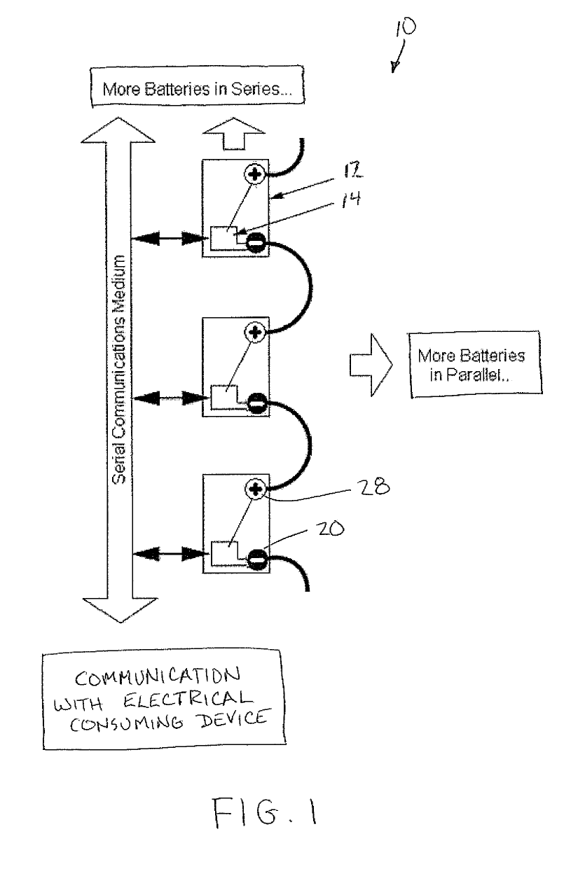

FIG. 2 is a perspective view of a battery having one of the modules of the battery management system supported thereon.

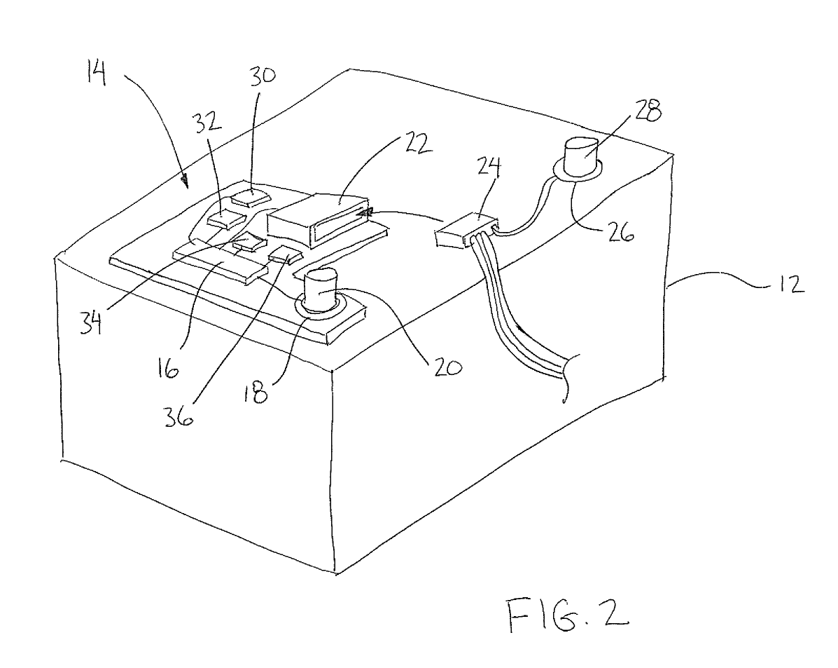

FIG. 3 is a schematic representation of one of the modules of the battery management system.

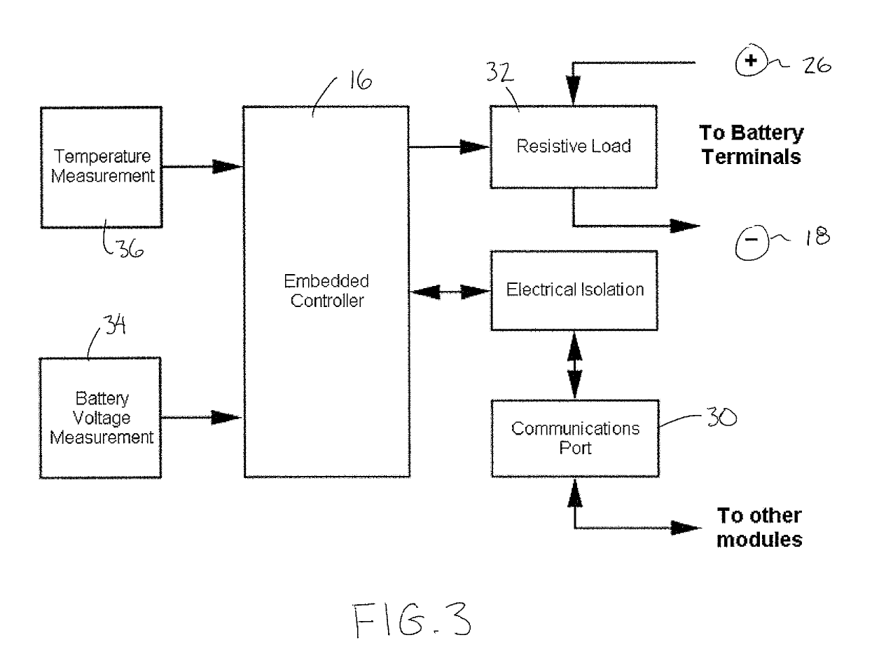

In the drawings like characters of reference indicate corresponding parts in the different figures.

### DETAILED DESCRIPTION

Referring to the accompanying figures there is illustrated a battery management system generally indicated by reference numeral 10. The system 10 is particularly suited for use with a plurality of batteries 12 which are interconnected with one another, for example in parallel, in series or a combination thereof. In the illustrated embodiment, the battery management system 10 is used with an interconnected group of batteries 12 which comprise 12 volt batteries suitable for use in hybrid or electrical vehicles, other types of vehicles, and marine vessels for example.

The system 10 comprises a plurality of individual modules 14 in which each module is arranged for association with a respective one of the batteries 12 of the group of interconnected batteries. Each module 14 comprises a single printed circuit board (PCB) in the form of a rigid panel structure which supports all of the components of the module commonly thereon for direct mounting onto the respective battery 12.

Each module includes an embedded controller 16 on the PCB which controls the functions of the module. Each module is autonomous in that its controller 16 operates to control an operating condition of the respective battery 12 with which it is associated independently of the control of the other batteries 12 by their respective controllers. The controller 16 communicates between all of the various components of the respective module 14.

A negative terminal connector 18 is commonly provided on the PCB with the controller 16 of each module. The negative terminal connector 18 is situated at one end of the PCB and generally comprises an annular contact ring having a through aperture therein which receives a portion of the negative terminal of the respective battery 12 therein or a fastener used to clamp onto the negative terminal of the battery. The annular contact ring defining the negative terminal connector 18 is fixed with respect to the PCB so that the panel structure of the PCB is fixed in relation to the battery when the negative terminal of the battery is clamped through the connector 18.

An electrical socket connector 22 is also mounted on the panel structure of the PCB of the module. The electrical socket connector 22 comprises a multi-pin connector for releasable mating connection with a suitable male connector 24 of a wiring harness. One of the pins of the multi-pin connection of the electrical socket 22 comprises a positive terminal connector 26 arranged for connection to the positive terminal 28 of the respective battery 12.

Other pins of the electrical socket connector 22 define a communications port 30 arranged for communication with a pair of wires defining a serial communication network. When used by a device which consumes the electrical power from the group of batteries 12, for example a vehicle, the serial communication network communicates with the vehicle to relay information from each module to the vehicle and to relay information from each module to other ones of the modules. Each module therefore has a serial communication protocol which communicates through the communication port 30 and over the serial communication network with the other modules.

A resistive element 32 comprising a resistive load is provided on the panel of the PCB of the module 14. The element 32 is coupled between the positive terminal connector 26 and the negative terminal connector 18 of the module by a transistor switch controlled by the respective controller 16 of the modules. The controller 16 thus has the ability to selectively connect and disconnect connection of the resistive element 32 between the positive and negative terminals of the battery by switching the transistor which couples the element 32 between the positive and negative terminal connectors of the module.

The printed circuit board of the module further includes a voltage sensor 34 which is also coupled between the negative terminal connector 18 and the positive terminal connector 26 of the module. The voltage senor 34 comprises a suitable circuit for measuring the voltage between the negative and positive terminals of the battery to relay the measured voltage back to the respective controller 16 of the modules. The controller 16 communicates with the communication port 30 to broadcast the measured voltage of the respective module to the controllers of other modules through their respective communication ports also. The controller in turn receives the measured voltage from each of the other modules 14 coupled to the other batteries respectively.

The controller 16 of each module, independently of the other controllers, compares the measured voltage of the respective module to the measured voltages of other modules and determines if the measured voltage is greater than any of the other voltages. When the measured voltage of the respective module is greater than any of the other voltages, the resistive element 32 is connected between the terminal connectors 18 and 26 to drain the battery only until the measured voltage is no longer greater than the other measured voltages. Measurement of the voltages by each of the controllers occurs continuously and the controller continuously compares these voltages relative to one another so that the transistor connecting each respective element is only switched on when the voltage measured by the respective sensory relays to the controller 16 to determine if the measured voltage is greater than other voltages. Once the measured voltage of the respective module is equal to or less than the measured voltages of the other modules, the transistor is switched off to disconnect connection of the resistive element 32 between the two positive and negative terminal connectors of the respective module.

Each module also includes a temperature sensor 36 commonly supported on the printed circuit board together with the voltage sensor, the controller, the negative terminal connector and the electrical socket connector of the respective module. The temperature sensor 36 communicates through the negative terminal connector 18 of the printed circuit board of the module for measuring heat of the negative terminal 20 of the respective battery. The negative terminal connector 18 is increased in dimension to provide a wide conductive pathway arranged to suitably conduct heat from the annular contact ring of the terminal connector 18 up to connection of the sensor 36 relative to the remaining portion of the terminal connector 18 up to its point of connection with the embedded controller 16. The temperature sensor 36 measures the temperature and relays this information back to the controller which then broadcasts the measured temperature through the communications port 30 onto the serial communication network communicating between all of the modules. Accordingly when used with an electrical consuming device which consumes battery power from the batteries 12 and which includes a serial communication network, this temperature is relayed back to the network of the device so that the device can make use of the temperature information for affecting the control of the device. In the application of a vehicle, the temperature of each battery as sensed by each respective module is independently broadcast onto the serial communications network by the respective controllers so that certain operating conditions of the vehicle can be adjusted to accommodate the sensed temperatures. All communications from the controllers of the respective modules are each communicated through a suitable electrical isolation circuit prior to being broadcast from the communications port 30 onto the serial communication network to allow all communication on the network to take place at a common electrical potential.

In use, where there is provided a plurality of interconnected batteries 12, a separate module 14 is provided for each battery. The modules are fixedly mounted and supported directly on the batteries by supporting the negative terminal connectors 18 onto the respective negative terminals 20 of the batteries. The only further connection required is the connection of a standardized harness to be plugged into the electrical socket connector 22 of each module which is in turn connected both to the serial communication network and the positive terminal of the respective battery. The modules are all identical to one another as well as the wiring harnesses connected to each module.

The autonomous embedded controller 16 of each module, upon connection, will automatically communicate over the serial communication network through its respective communication port 30 to identify other modules connected to the network so that it can assign itself a unique identification relative to the other modules.

Once a device consuming electrical power from the batteries is in use, the voltage sensor and the temperature sensor of each module automatically and continuously check the voltage and temperature of the respective battery and broadcast the measured voltage and measured temperature onto the serial communication network along with the respective identification of the module. Each module then receives the measured voltages from the other modules over the serial communication network so that it can continuously and repeatedly calculate if the measured voltage of the respective battery is greater than other measured voltages of other batteries. The resistive element 32 is connected between the respective positive and negative terminal connectors only while the measured voltage remains greater than the other measured voltages received from other modules by operation of the transistor associated with resistive element 32. In this manner any batteries having a greater electrical potential or voltage between terminals is drained by the respective resistive element 32 until its voltage is balanced with the voltages of the other batteries, thus eliminating problems with imbalances between batteries in a group of interconnected batteries without relying on a single master controller which requires programming relative to the plurality of batteries connected thereto.

In some embodiments, the controller may only connect the resistive element between the negative terminal connector and the positive terminal connector when the sensed voltages exceeds the other voltages by a prescribed allowance range, for example expressed as a percentage, so that very small differences are permitted and so that the resistive element is not excessively cycled between on and off states. In yet further arrangements, the connection of the resistive element between the negative terminal connector and the positive terminal connector may be prevented if the battery is near full charge and/or near depleted of charge.

As described herein, the battery management system of the present invention is generally comprised of identical, interchangeable modules that are connected with simple wiring, and are flexible in their application. Each module is connected to a 12V battery and monitors its voltage as well as the temperature from the negative terminal. This is done cheaply by integrating the negative terminal connection into the PCB design, and fixing a surface mount electronic temperature sensor near a copper heat guide. There is a serial communication protocol (based on SAE J1939 CAN Bus) that is used between the modules, meaning that the same two wires are run between all the modules, and they can talk to each other in this way. The modules use an arbitration scheme to assign a unique address to each other once they are connected to the network. Other devices can listen onto this CAN bus for data logging purposes or to take corrective action like reducing the top speed or disabling a vehicle to protect the batteries. The devices broadcast their battery voltage and temperature to the network on discrete intervals. Each module compares itself to the others in the system and can switch on a small resistor to slowly drain the battery if it is above the others.

The device is encapsulated in an epoxy compound to form a durable and relatively indestructible brick, with the negative connection and a communication connector exposed. As each of these modules is exactly the same, and communicates through an opto-isolated CAN port so that it doesn't matter if they are at significantly different voltage levels, they all talk at one particular voltage level. In this way you can take n-number of modules, connect them to an arbitrary battery bank, which could be composed of series, parallel, or combined strings, and they will effectively balance every battery in the system. Accordingly the battery management system according to the present invention is truly open-ended, and suited to high volume, low cost manufacturing.

A summary of the components of each module described above will now be described in the following.

### Negative Terminal Connection

The negative terminal connection of the device performs the following 3 main functions: i) provides a physical mounting point for the BMS module; ii) provides an electrically conductive pathway for use battery voltage measurement and equalization using the resistive load; and iii) provides a thermally conductive pathway for battery temperature measurement.

### Temperature Measurement

The temperature of the battery negative terminal is measured using a temperature sensor mounted on the surface of the circuit board. The shape of the circuit board is designed in such a way to transmit heat between the negative terminal of the battery and the sensor. The output signal from the temperature sensor is passed through a signal conditioning circuit and to the embedded controller where the measurement is digitized.

### Battery Voltage Measurement

The voltage of the battery is measured between the negative terminal, using the negative mounting point, and the positive terminal, using a wire terminated at the electrical connector. This voltage is passed through a signal conditioning circuit and passed to the embedded controller where the measurement is digitized.

### Embedded Controller

The embedded controller takes measurements of the battery voltage and temperature, digitizes these measurements, and broadcasts this status on the communications port. The controller also keeps track of the status of the other batteries in the system, and makes a decision whether or not to switch on the resistive load to equalize the local battery with the rest of the batteries in the pack.

### Resistive Load

A transistor switched resistive load is used to provide balancing functionality in the event that the local battery becomes significantly overcharged with respect to the rest of the pack.

### Electrical Isolation

Since all modules are connected to different batteries in an arbitrary parallel/series combination, the electrical reference of each module in the system may differ considerably. Therefore, the communication between the modules must be level-shifted to a common level as specified by the system integrator. Electrical isolation between the internal circuitry and the communications port for each module is provided to allow this communication to take place at a common electrical potential.

### Communications Port

A communications transceiver is necessary to implement the specific hardware level tasks required by the communication protocol. This typically includes a specially designed integrated circuit which is widely available and commonly used.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A battery management system for monitoring a plurality of interconnected batteries, the system comprising a plurality of modules arranged for connection to respective ones of the batteries, each module comprising:
a negative terminal connector arranged for connection to a negative terminal of the respective battery;
a positive terminal connector arranged for connection to a positive terminal of the respective battery;
a voltage sensor arranged for measuring a voltage between the negative terminal connector and the positive terminal connector;
a communication port arranged to communicate the voltage sensed by the voltage sensor with the communication ports of other ones of the modules;
a resistive element arranged to be selectively connected between the negative terminal connector and the positive terminal connector; and
a controller arranged to connect the resistive element between the negative terminal connector and the positive terminal connector responsive to the voltage sensed by the voltage sensor being greater than voltages of other ones of the batteries which are sensed by the voltage sensors of the respective modules.

2. The system according to claim 1 wherein the controller of each module is autonomous and is arranged to selectively connect the respective resistive element between the respective negative terminal connector and the respective positive terminal connector independently of operation the other controllers.

3. The system according to claim 1 wherein the controller of each module is arranged to autonomously assign a unique identification to the module relative to other modules communicating with one another through the respective communication ports.

4. The system according to claim 1 wherein the controller is arranged to only connect the resistive element between the negative terminal connector and the positive terminal connector when the voltage sensed by the respective voltage sensor is greater by a prescribed allowance range than voltages of other ones of the batteries which are sensed by the voltage sensors of the respective modules of the other ones of the batteries.

5. The system according to claim 1 in combination with a plurality of batteries connected in parallel.

6. The system according to claim 1 in combination with a plurality of batteries connected in series.

7. The system according to claim 1 wherein the negative terminal connector, the voltage sensor, the communication port, the resistive element, and the controller of each module are commonly supported on a common printed circuit board of the module.

8. The system according to claim 7 wherein the printed circuit board is arranged to be supported directly on a terminal of the respective battery.

9. The system according to claim 1 wherein the communication port of each module is arranged to communicate with other modules on a common serial communication network using a serial communication protocol.

10. The system according to claim 9 in combination with a device which consumes electrical power from the plurality of interconnected batteries and which includes an operating condition responsive to information communicated by the modules through their respective communication ports to the serial communication network.

11. The system according to claim 1 wherein each module includes a temperature sensor arranged for measuring a temperature of the respective battery.

12. The system according to claim 11 wherein the controller is arranged to broadcast the temperature sensed by the respective temperature sensor onto a serial communication network through the respective communication port.

13. The system according to claim 11 wherein the temperature sensor is arranged for measuring a temperature of the battery through one of the terminal connectors.

14. The system according to claim 11 wherein the temperature sensor of each module is arranged to be supported on a common printed circuit board with the controller and one of the terminal connectors of the respective module.

15. A module for monitoring a battery interconnected with other batteries in a battery management system, the module comprising:
a negative terminal connector arranged for connection to a negative terminal of the battery;
a positive terminal connector arranged for connection to a positive terminal of the battery;
a voltage sensor arranged for measuring a voltage between the negative terminal connector and the positive terminal connector;
a temperature sensor arranged for measuring a temperature of the battery;
a communication port arranged to transmit the voltage measured by the voltage sensor and the temperature measured by the temperature sensor to the battery management system;
the temperature sensor being connected to one of the terminal connectors so as to be arranged to measure a temperature of the battery through the respective terminal of the battery.

16. A module for monitoring a battery interconnected with other batteries in a battery management system, the module comprising:
a negative terminal connector arranged for connection to a negative terminal of the battery;
a positive terminal connector arranged for connection to a positive terminal of the battery;
a voltage sensor arranged for measuring a voltage between the negative terminal connector and the positive terminal connector;
a temperature sensor arranged for measuring a temperature of the battery;
a communication port arranged to transmit the voltage measured by the voltage sensor and the temperature measured by the temperature sensor to the battery management system; and
a printed circuit board commonly supporting the voltage sensor, the temperature sensor and the communication port thereon;
the printed circuit board being arranged to be supported directly on one of the terminals of the battery.

17. The module according to claim 16 wherein the temperature sensor is arranged to be connected to one of the terminal connectors so as to be arranged to measure a temperature of the battery through the respective terminal of the battery.
